(19) United States
(12) Patent Application Publication
(10) Pub. No.: US 2019/0047855 A1
(43) Pub. Date: Feb. 14, 2019

(54) PD-CATALYZED DECOMPOSITION OF FORMIC ACID

(71) Applicant: EVONIK DEGUSSA GMBH, Essen (DE)

(72) Inventors: Rui SANG, Liaocheng City (CN); Jie LIU, Solna (SE); Kaiwu DONG, Bo Zhou (CN); Ralf JACKSTELL, Rostock (DE); Matthias BELLER, Ostseebad Nienhagen (DE); Robert FRANKE, Marl (DE)

(73) Assignee: EVONIK DEGUSSA GMBH, Essen (DE)

(21) Appl. No.: 16/043,657

(22) Filed: Jul. 24, 2018

(30) Foreign Application Priority Data
Aug. 8, 2017 (EP) 17185340.1

(51) Int. Cl. C01B 3/22; C01B 5/00; C01B 32/40; C01B 32/50; B01J 31/24

(52) U.S. Cl. CPC C01B 3/22; C01B 5/00; C01B 32/40; B01J 2531/824; B01J 31/2409; C01B 2203/0277; C01B 32/50

(57) ABSTRACT

Process for Pd-catalyzed decomposition of formic acid

The invention relates to a process for Pd-catalyzed decomposition of formic acid (HCOOH).

Formic acid is used in chemical reactions as an acid or solvent for example but may also be generated as a byproduct of a reaction. On account of its corrosive or strong-smelling properties, it may be desirable to remove the formic acid.

The present invention has for its object to provide a process in which formic acid is efficiently decomposed with the aid of a catalyzed process.

The object is achieved by a process according to Claim 1.

Process comprising the process steps of:

a) presence of formic acid;

b) addition of a compound comprising Pd, wherein the Pd is capable of forming a complex;

c) addition of a compound of general formula (I):

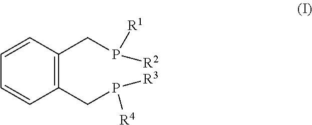

wherein R¹, R², R³, R⁴ are each independently selected from: —H, —(C₁-C₁₂)-alkyl, —O—(C₁-C₁₂)-alkyl, —(C₄-C₁₄)-aryl, —O—(C₄-C₁₄)-aryl, cycloalkyl, —(C₁-C₁₂)-heteroalkyl, —O—(C₁-C₁₂)-heteroalkyl, —(C₃-C₁₄)-heteroaryl, —O—(C₃-C₁₄)-heteroaryl, —COO-alkyl, —COO-aryl, —C—O-alkyl, —C—O-aryl, NH₂, halogen and the residues are also capable of forming a larger condensed ring;

wherein the recited alkyl groups, aryl groups, cycloalkyl, heteroalkyl groups, heteroaryl groups may be substituted as follows:

—(C₁-C₁₂)-alkyl, —O—(C₁-C₁₂)-alkyl, halogen;

and at least one of the radicals R¹, R², R³, R⁴ does not represent phenyl;

d) addition of MeOH;

e) heating of the reaction mixture to decompose the formic acid.

In one variant of the process, the compound in process step b) is selected from: Pd(acac)₂, PdCl₂, Pd(dba)₃*CH₃Cl (dba=dibenzylideneacetone), Pd(OAc)₂, Pd(TFA)₂, Pd(CH₃CN)Cl₂.

In one variant of the process, the compound in process step b) is Pd(OAc)₂.

In one variant of the process, the process comprises the additional process step f):

f) addition of an acid.

In one variant of the process, the acid in process step f) is selected from: H₂SO₄, CH₃SO₃H, CF₃SO₃H, PTSA.

In one variant of the process, the acid in process step f) is PTSA.

In one variant of the process, R¹, R², R³, R⁴ are each independently selected from: —(C₁-C₁₂)-alkyl, —O—(C₁-C₁₂)-alkyl, —(C₄-C₁₄)-aryl, —O—(C₄-C₁₄)-aryl, cycloalkyl, —(C₁-C₁₂)-heteroalkyl, —O—(C₁-C₁₂)-heteroalkyl, —(C₃-C₁₄)-heteroaryl, —O—(C₃-C₁₄)-heteroaryl, —COO-alkyl, —COO-aryl, —C—O-alkyl, —C—O-aryl, NH₂, halogen and the residues are also capable of forming a larger condensed ring;

wherein the recited alkyl groups, aryl groups, cycloalkyl, heteroalkyl groups, heteroaryl groups may be substituted as follows:

—(C₁-C₁₂)-alkyl, —O—(C₁-C₁₂)-alkyl, halogen;

and at least one of the radicals R¹, R², R³, R⁴ does not represent phenyl.

In one variant of the process, R¹, R², R³, R⁴ are each independently selected from: —(C₁-C₁₂)-alkyl, —(C₄-C₁₄)-aryl, cycloalkyl, —(C₁-C₁₂)-heteroalkyl, —(C₃-C₁₄)-heteroaryl, halogen and the residues are also capable of forming a larger condensed ring;

wherein the recited alkyl groups, aryl groups, cycloalkyl, heteroalkyl groups, heteroaryl groups may be substituted as follows:

—(C₁-C₁₂)-alkyl, —O—(C₁-C₁₂)-alkyl, halogen;

and at least one of the radicals R¹, R², R³, R⁴ does not represent phenyl.

In one variant of the process, R¹, R², R³, R⁴ are each independently selected from: —(C₁-C₁₂)-alkyl, cycloalkyl. —(C₃-C₁₄)-heteroaryl and the residues are also capable of forming a larger condensed ring;

wherein the recited alkyl groups, cycloalkyl, heteroaryl groups may be substituted as follows:

—(C₁-C₁₂)-alkyl, —O—(C₁-C₁₂)-alkyl, halogen,

and at least one of the radicals R¹, R², R³, R⁴ does not represent phenyl.

In one variant of the process, R¹, R⁴ are each independently selected from: —(C₁-C₁₂)-alkyl, cycloalkyl and the residues are also capable of forming a larger condensed ring;

wherein the recited alkyl groups, cycloalkyl may be substituted as follows:

—(C₁-C₁₂)-alkyl, —O—(C₁-C₁₂)-alkyl, halogen.

In one variant of the process, R², R³ each independently represent —(C₃-C₁₄)-heteroaryl, wherein the recited heteroaryl groups may be substituted as follows: —(C₁-C₁₂)-alkyl, —O—(C₁-C₁₂)-alkyl, halogen.

In one variant of the process, the compound of general formula (I) is selected from the structures (1) to (3):

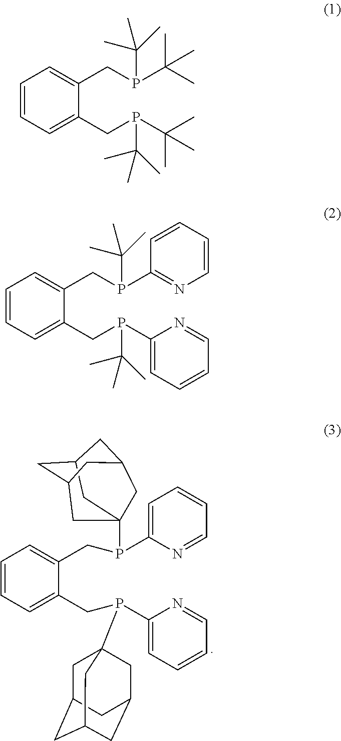

In one variant of the process, the compound of general formula (I) has the structure (2):

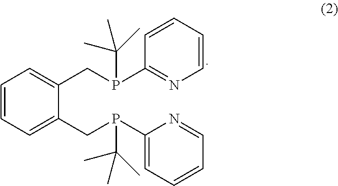

In one variant of the process, the compound of general formula (I) has the structure (3):

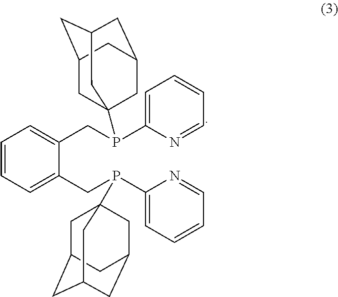

The invention is elucidated in detail hereinafter by working examples.

Investigation of Pd-Catalyzed Decomposition of Formic Acid

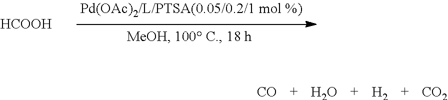

Under an argon atmosphere [Pd(OAc)₂] (4.48 mg, 0.02 mmol, 0.05 mol %), Ligand L (0.08 mmol, 0.2 mol %), PTSA.H₂O (76 mg, 0.4 mmol, 1.0 mol %) were introduced into an autoclave. (Addition of individual constituents was eschewed in individual experiments as per following table.) Subsequently, MeOH (6.5 ml) and HCOOH (40 mmol, 1.50 ml) were injected with a syringe. The autoclave was then purged three times with nitrogen (5 bar). The reaction mixture was heated to 100° C. and held at this temperature for 18 h. After this time, the autoclave was cooled to room temperature.

Pressure was measured by electronic autoclave pressure recording sensors.

The selectivity of CO, H₂ and CO₂ was determined by gas GC analysis.

The results are summarized in the following table:

TABLE

| | | | Total pressure | CO | H₂ | CO₂ |
|---|---|---|---|---|---|---|
| Pd | L | PTSA | (bar) | (bar, %) | (bar, %) | (bar, %) |
| − | − | − | 0.3 | 0.009, 3 | 0.147, 49 | 0.144, 48 |
| + | − | − | 0.4 | 0.020, 5 | 0.192, 48 | 0.188, 47 |
| − | − | + | 0.2 | 0.020, 10 | 0.092, 46 | 0.088, 44 |
| − | L4 | − | 0.5 | 0.055, 11 | 0.28, 56 | 0.165, 33 |
| + | − | + | 0.2 | 0.012, 6 | 0.126, 63 | 0.062, 31 |
| + | L4 | − | 2.2 | 1.474, 67 | 0.396, 18 | 0.330, 15 |
| + | L4 | + | 5.5 | 4.840, 88 | 0.385, 7 | 0.275, 5 |
| + | L3 | + | 2.2 | 1.914, 87 | 0.176, 8 | 0.110, 5 |
| + | L5 | + | 6.0 | 5.04, 84 | 0.54, 9 | 0.42, 7 |
| − | L3 | − | 0.8 | 0.24, 30 | 0.32, 40 | 0.24, 30 |

+: added
−: not added

As is shown by the experiments described above, the object is achieved by a process according to the invention.

1. Process comprising the process steps of:
a) presence of formic acid;
b) addition of a compound comprising Pd, wherein the Pd is capable of forming a complex;
c) addition of a compound of general formula (I): 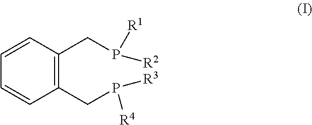
wherein R¹, R², R³, R⁴ are each independently selected from: —H, —(C₁-C₁₂)-alkyl, —O—(C₁-C₁₂)-alkyl, —(C₄-C₁₄)-aryl, —O—(C₄-C₁₄)-aryl, cycloalkyl, —(C₁-C₁₂)-heteroalkyl, —O—(C₁-C₁₂)-heteroalkyl, —(C₃-C₁₄)-heteroaryl, —O—(C₃-C₁₄)-heteroaryl, —COO-alkyl, —COO-aryl, —C—O-alkyl, —C—O-aryl, NH₂, halogen and the residues are also capable of forming a larger condensed ring;
wherein the recited alkyl groups, aryl groups, cycloalkyl, heteroalkyl groups, heteroaryl groups may be substituted as follows:
—(C₁-C₁₂)-alkyl, —O—(C₁-C₁₂)-alkyl, halogen;
and at least one of the radicals R¹, R², R³, R⁴ does not represent phenyl;
d) addition of MeOH;
e) heating of the reaction mixture to decompose the formic acid.

2. Process according to claim 1,
wherein the compound in process step b) is selected from:
Pd(acac)₂, PdCl₂, Pd(dba)₃*CH₃Cl (dba=dibenzylideneacetone), Pd(OAc)₂, Pd(TFA)₂, Pd(CH₃CN)Cl₂.

3. Process according to claim 1,
wherein the compound in process step b) is Pd(OAc)₂.

4. Process according to claim 1,
wherein the process comprises additional process step f):
f) addition of an acid.

5. Process according to claim 4,
wherein the acid in process step f) is selected from: H₂SO₄, CH₃SO₃H, CF₃SO₃H, PTSA.

6. Process according to claim 4,
wherein the acid in process step f) is PTSA.

7. Process according to claim 1,
wherein R¹, R², R³, R⁴ are each independently selected from: —(C₁-C₁₂)-alkyl, —O—(C₁-C₁₂)-alkyl, —(C₄-C₁₄)-aryl, —O—(C₄-C₁₄)-aryl, cycloalkyl, —(C₁-C₁₂)-heteroalkyl, —O—(C₁-C₁₂)-heteroalkyl, —(C₃-C₁₄)-heteroaryl, —O—(C₃-C₁₄)-heteroaryl, —COO-alkyl, —COO-aryl, —C—O-alkyl, —C—O-aryl, NH₂, halogen and the residues are also capable of forming a larger condensed ring;
wherein the recited alkyl groups, aryl groups, cycloalkyl, heteroalkyl groups, heteroaryl groups may be substituted as follows:
—(C₁-C₁₂)-alkyl, —O—(C₁-C₁₂)-alkyl, halogen;
and at least one of the radicals R¹, R², R³, R⁴ does not represent phenyl.

8. Process according to claim 1,
wherein R¹, R², R³, R⁴ are each independently selected from: —(C₁-C₁₂)-alkyl, —(C₄-C₁₄)-aryl, cycloalkyl, —(C₁-C₁₂)-heteroalkyl, —(C₃-C₁₄)-heteroaryl, halogen and the residues are also capable of forming a larger condensed ring;
wherein the recited alkyl groups, aryl groups, cycloalkyl, heteroalkyl groups, heteroaryl groups may be substituted as follows:
—(C₁-C₁₂)-alkyl, —O—(C₁-C₁₂)-alkyl, halogen;
and at least one of the radicals R¹, R², R³, R⁴ does not represent phenyl.

9. Process according to claim 1,
wherein R¹, R², R³, R⁴ are each independently selected from: —(C₁-C₁₂)-alkyl, cycloalkyl, —(C₃-C₁₄)-heteroaryl and the residues are also capable of forming a larger condensed ring;
wherein the recited alkyl groups, cycloalkyl, heteroaryl groups may be substituted as follows:
—(C₁-C₁₂)-alkyl, —O—(C₁-C₁₂)-alkyl, halogen,
and at least one of the radicals R¹, R², R³, R⁴ does not represent phenyl.

10. Process according to claim 1,
wherein R¹, R⁴ are each independently selected from: —(C₁-C₁₂)-alkyl, cycloalkyl and the residues are also capable of forming a larger condensed ring;
wherein the recited alkyl groups, cycloalkyl may be substituted as follows:
—(C₁-C₁₂)-alkyl, —O—(C₁-C₁₂)-alkyl, halogen.

11. Process according to claim 1,
wherein R², R³ each independently represent —(C₃-C₁₄)-heteroaryl,
wherein the recited heteroaryl groups may be substituted as follows:
—(C₁-C₁₂)-alkyl, —O—(C₁-C₁₂)-alkyl, halogen.

12. Process according to claim 1,
wherein the compound of general formula (I) is selected from the structures (1) to (3):

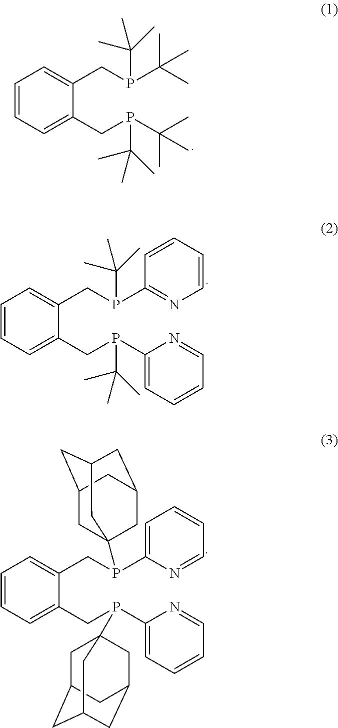

13. Process according to claim 1,
wherein the compound of general formula (I) has the structure (2):

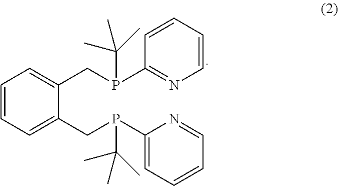

14. Process according to claim 1,
wherein the compound of general formula (I) has the structure (3): [chemical structure]
